(19) United States
(12) Patent Application Publication
(10) Pub. No.: US 2013/0337471 A1
(43) Pub. Date: Dec. 19, 2013

(54) CELL IDENTIFICATION WITH NANOPARTICLES, COMPOSITIONS AND METHODS RELATED THERETO

(71) Applicants: Shuming Nie, Atlanta, GA (US); Jian Liu, Los Angeles, CA (US); Brad A. Kairdolf, Lilburn, GA (US)

(72) Inventors: Shuming Nie, Atlanta, GA (US); Jian Liu, Los Angeles, CA (US); Brad A. Kairdolf, Lilburn, GA (US)

(73) Assignee: EMORY UNIVERSITY, Atlanta, GA (US)

(21) Appl. No.: 13/517,895

(22) Filed: Jun. 14, 2012

(51) Int. Cl. G01N 21/76

(52) U.S. Cl. 435/7.23

(57) ABSTRACT

The present disclosure provides a method for identifying rare or low-abundant biological entities such as Hodgkin's and Reed-Sternberg cells, circulating tumor cells in peripheral blood, circulating fetal cells, stem cells, somatic cells, HIV-infected T cells, bacteria or viruses in water, adenoviruses, enteroviruses, hepatitis A and E, dengue, Swine Flu, bovine diarrhea, and protozpa/helminthes. The method uses a suite of nanoparticle-conjugated agents to mark biological targets of interest for subsequent fluorescence imaging. In certain embodiments, the nanoparticle-conjugated agents are fluorescent semiconductor nanocrystals conjugated with antibodies with affinity for CD15, CD30, CD45, and Pax5. In certain embodiments, a method is developed to differentiate Hodgkin's and Reed-Sternberg (HRS) cells from amongst surrounding immune cells such as T and B lymphocytes with greater specificity and precision than traditional immunohistochemistry (IHC) for the diagnosis of Hodgkin's lymphoma.

### CROSS REFERENCE TO RELATED APPLICATIONS

This non-provisional application claims priority to U.S. Provisional Application No. 61/489,167 filed Jun. 17, 2011, hereby incorporated by reference in its entirety.

### STATEMENT REGARDING FEDERALLY FUNDED RESEARCH

This invention was made with government support under Grants U54CA119338 and RO1CA108468 awarded by the National Institutes of Health. The government has certain rights in the invention.

### FIELD

The disclosure is generally related to methods for identifying biological entities and diagnosing medical conditions via nanoparticles. In certain embodiments, the nanoparticles are fluorescent semiconductor quantum dots conjugated with antibodies capable of differentiating Hodgkin's and Reed-Sternberg (HRS) cells from among surrounding immune cells such as T and B lymphocytes for the diagnosis of Hodgkin's lymphoma.

### BACKGROUND

With over 200 types of cancer, each with several variants that progress differently in each patient, the diagnosis and treatment of cancer remains a challenge. The American Cancer Institute estimated that over 1.5 million Americans would be diagnosed with cancer and over 500,000 would die from cancer in 2010 alone. Current imaging techniques such as x-ray, computed tomography, ultrasound, radionuclide imaging, and MRI have been used for detecting, diagnosing, and monitoring some forms of cancer. However, these techniques do not have fine enough spatial-resolution to reliably identify rare cells in the complex microenvironments of heterogeneous tumor tissue specimens and cell populations for the diagnosis of some cancers like Hodgkin's lymphoma. Fluorescent dyes, such as fluorophores and small organic dyes, have shown improved resolution of biological components. However, these fluorescent dyes suffer from (1) irreversible reduction in fluorescence intensity over time (photobleaching), (2) complexity due to needing a different excitation wavelength for each fluorescent dye, and (3) difficulty in multiplexing due to the overlapping emission spectra for organic dyes.

Like fluorophores and small organic dyes, some kinds of nanoparticles exhibit fluorescence upon excitation with electromagnetic radiation. As one example, quantum dots (QDs) are semiconductor nanocrystals often 2-10 nm in diameter and typically composed of atoms from the II/VI or III/V group of elements. The diameter of these QDs is on the same order of magnitude as the wavelength of the electron wave function in three dimensions resulting in quantum-confinement of the electrons. In bulk materials, the band gap of semiconductors is constant because the electrons are free within a continuous energy state. When there is quantum-confinement in nanoparticles, however, the energy states become discrete so the bandgap varies with the size of the confined dimensions of the nanoparticles. Consequently, researchers can tune the emission spectra for their needs by varying the diameter of the QDs. QDs are described in U.S. Pat. No. 6,207,392. In comparison with organic dyes and fluorescent proteins, quantum dots have unique optical properties such as size-tunable light emission, superior signal brightness, resistance to photobleaching, and simultaneous excitation of multiple fluorescence colors (multiplexing).

These properties are believed to be most promising for improving the sensitivity and multiplexing capabilities of molecular pathology and in vitro diagnostics. Nanoparticles, such as semiconductor nanocrystals, may be conjugated with biological components such as antibodies, nucleotides, proteins, or subcellular organelles that have the affinity to interact with other biological components. The nanoparticles can tag the target biological components for subsequent detection via fluorescent emission. U.S. Pat. No. 6,306,610. The simultaneous use of multiple molecular biomarkers can improve both diagnostic sensitivity and specificity. In addition, because multiplexed QD staining can be carried out on intact cells and tissue specimens, it is expected to provide correlated molecular and morphological information. This type of integrated biomarker and morphological data is not available from traditional analytical methods such as mass spectrometry, gene chips, protein microarrays, and polymerase chain reactions (PCR).

Researchers have used QDs for sentinel lymph-node (SLN) drainage mapping for the identification of lymph nodes containing the metastatic cancer cells shed by breast cancer. Hama et al., Breast Cancer Res. Treat. 2007, 103(1):23-28. Other researchers have used QDs for detecting lung cancer, U.S. Published Patent Application No. 2010/0317002 A1, and gastric cancer, U.S. Published Patent Application No. 2010/0055041 A1. Bioconjugated nanoparticles have also been used to image human prostate cancer growing in mice. Gao et al., Nature Biotechnology. 2004, 22(8): 969-976.

However, some types of cancer are more difficult to diagnose because characteristic malignant cells make up a low percentage of the infiltrating cells. Malignant Hodgkin's and Reed-Sternberg (HRS) cells, for instance, make up only about 1% of the tumor infiltrating cells in lymph node tissues leaving the morphological (H and E staining) and immunohistochemistry (IHS) examinations vulnerable to indecisive or ambiguous diagnosis. While fine-needle aspiration of the lymph nodes is a minimally invasive, rapid, and cost effective method of monitoring the progression of small lymphocytic lymphoma (SLL) and chronic lymphocytic leukemia (CLL), but it results in a high percentage of false-negative cases of Hodgkin's lymphoma due in large part to the paucity of Reed-Sternberg cells. Reading at el., Am. J. Clin. Pathol. 2007, 128:571-78. Therefore, there remains a need for a method of more accurately identifying and diagnosing disease when a paucity of characteristic diseased cells exists within a larger heterogeneous tissue.

### SUMMARY

The present disclosure provides a method to identify rare biological targets from complex or heterogeneous surroundings using nanoparticle-conjugated markers. The disclosure relates to a method of using fluorescent nanocrystals to mark biological targets of interest for subsequent fluorescent detection.

In certain embodiments, the disclosure relates to methods of detecting a cell in a tissue sample comprising a) mixing the sample with a first marker that binds cell biomarker providing marker conjugated cells; b) mixing the marker conjugated cells with a secondary marker conjugated to a fluorescent entity that binds to the first marker providing marker conjugated cells marked with fluorescent entities; c) exposing the sample with marker conjugated cells marked with fluorescent entities to light; d) detecting a fluorescence pattern for a cell indicative of the cell biomarker. Typically, the tissue sample is lymphoma tissue and steps a and b are repeated two or more times with first markers that bind different cell biomarkers. The fluorescent entity is typically a nanoparticle.

Although, typically methods provided herein use a two tier marker system, it is also contemplated that the methods disclosed herein may be used by directly conjugating a nanoparticle to a marker that binds a cell biomarker without the using a secondary signal. Thus, in certain embodiments, the disclosure relates to methods of detecting a cell in a tissue sample comprising a) mixing the tissue sample with antibody-conjugated nanoparticles each having an epitope to a target biomolecule, providing an antibody conjugated cell marked with an antibody-conjugated nanoparticle, wherein two or more antibody-conjugated nanoparticles are used that fluoresces at detectably different wavelengths from each other and bind different target biomolecules; b) exposing the tissue sample with antibody conjugated cells marked with a nanoparticle to light; and c) detecting a fluorescence pattern for a targeted cell.

In certain embodiments, the disclosure relates to methods of detecting a cell in a tissue sample comprising a) mixing the sample with a first primary antibody with an epitope to a first cell biomarker and a second primary antibody with an epitope to a second cell biomarker providing antibody conjugated cells comprising the first and second cell biomarkers; b) mixing the antibody conjugated cells with a first secondary antibody conjugated to a first nanoparticle with an epitope to the first primary antibody and a second secondary antibody conjugated to a second nanoparticle with an epitope to the second primary antibody providing antibody conjugated cells marked with first and second nanoparticles, provided that the first and second nanoparticles fluoresce at detectably different wavelengths; c) exposing the sample with antibody conjugated cells marked with first and second nanoparticles to light; and d) detecting a fluorescence pattern for a cell indicative of the first and second cell biomarkers.

In certain embodiments, the disclosure relates to repeating steps a and b wherein the first and second cell biomarkers are changed or not the same as the cell biomarker used in the first instance.

In certain embodiments, the disclosure contemplates the direct use of antibody-nanoparticle conjugates that bind the first and second cell biomarkers. Such cell biomarkers may include proteins, glycoproteins or glycans. The cell biomarkers are typically chosen because their expression is characteristic of a specific cell type

In certain embodiments, the method above further comprises the steps of e) assigning a first pattern fluorescence to a normal cell; and f) correlating a second color pattern to an irregular cell. In further embodiments, one reports the presence of an irregular cell to a subject from which the sample was obtained. Typically, the tissue sample is human lymphoma tissue and the normal cell is a T or B lymphocyte and the irregular cell is a Hodgkin's and Reed-Sternberg cell. Typically, the first cell biomarker is selected from CD15, CD30, CD45, and Pax5 and the second cell biomarker is selected from CD15, CD30, CD45, and Pax5 provided the second cell biomarker is not the same as the first cell biomarker. In certain embodiments, Hodgkin's lymphoma is diagnosed by the distinct emission pattern of the nanoparticle-conjugated markers. In certain embodiments, benign lymphoid hyperplasia is diagnosed by the absence of the distinct emission pattern of the nanoparticle-conjugated markers attached to Hodgkin's and Reed-Sternberg cells.

In certain embodiments, the irregular cell is less than about 5, 4, 3, 2, 1, 0.5% of the cells in the sample.

In one embodiment, a suite of nanoparticle-conjugated markers with distinct emission spectra and with distinct affinity for specific epitopes is selected. In certain embodiments, a target is identified in a sample by mixing it with a nanoparticle-conjugated marker with affinity for the target providing a marked target. In certain embodiments, the target is at least one antigen. In some embodiments, the target is at least one primary antibody with affinity to at least one biomolecule in the sample such as an antigenic entity. In certain embodiments, the marker in the nanoparticle-conjugated marker is a secondary antibody. In certain embodiments, the nanoparticle in the nanoparticle-conjugated marker is a fluorescent nanocrystal, semiconductor nanoparticle, or quantum dot.

In specific embodiments, the antigenic entities targeted by nanoparticle-conjugated antibodies are comprised of CD15, CD30, CD45, and Pax5 for the detection of Hodgkin's and Reed-Sternberg cells. In certain embodiments, the multiplexing staining method is applied to a human lymphoma tissue sample. In certain embodiments, multiplexed staining is achieved by incubating a sample with a mixture of primary antibodies CD30 (e.g., mouse monoclonal) and Pax5 (e.g., rabbit polyclonal), incubated with a mixture of secondary antibody conjugated quantum dots (e.g., goat antirabbit QD655 and goat antimouse QD605), incubated with another mixture of primary antibodies (e.g., CD15 mouse monoclonal and CD45 rabbit polyclonal), then incubated with a mixture of secondary antibody conjugated quantum dots (e.g., goat antirabbit QD565 and goat antimouse QD525). In certain embodiments, the method of applying the suite of nanoparticle-conjugated markers to a human lymphoma tissue results in malignant Hodgkin's and Reed-Sternberg cells' membranes fluorescing a predetermined first color (e.g., red), their nuclear fluorescing a predetermined second color (e.g., blue), and their Golgi fluorescing a predetermined color (e.g., red and white).

In certain embodiments, the disclosure relates to methods comprising mixing a sample with a nanoparticle-conjugated marker with affinity for a target providing a marked target wherein said target is a primary antibody with affinity to a cell biomarker. The cell biomarker is a cell surface biomolecule or an intracellular biomolecule and said sample comprises a human lymphoma tissue that has been incubated with at least one primary antibody each primary antibody having an epitope to a fragment of a protein selected from the group consisting of CD15, CD30, CD45, and Pax5.

In further embodiments, the method further comprises the step of mixing the human lymphoma tissue with a second set of primary antibodies having epitopes selected from the group consisting of CD15, CD30, CD45, and Pax5 that were not used in the first instance wherein the nanoparticle-conjugated marker is a mixture of nanoparticle-conjugated secondary antibodies each with affinity to a different primary antibody used in the second instance.

In certain embodiments, a kit is comprised of primary antibodies with epitopes for CD15, CD30, CD45, and Pax5 and a plurality of quantum dot-conjugated secondary antibodies to the primary antibodies. In certain embodiments, the nanoparticle-conjugated markers are water soluble and can be administered in vivo. In certain embodiments, a kit is compiled comprising primary antibodies and a plurality of nanoparticle-conjugated secondary antibodies that are water soluble. In certain embodiments, at least one of the types of nanoparticle-conjugated marker is linked to therapeutics. In certain embodiments, the disclosure contemplates that the nanoparticle-conjugated marker enables both imaging and therapeutic delivery of drugs to a target. In certain embodiments, the nanoparticle-conjugated markers are not water soluble and are administered in vitro on clinical diagnostic materials.

Typically the cell biomarker is a cell surface biomolecule or an intracellular biomolecule. CD15, CD30, and CD45 are cell surface biomolecules, and the Pax5 protein is an intracellular nuclear biomarker. Other examples of common intracellular markers this method could be used to detect include estrogen receptor (ER) and progesterone receptor (PR), for pathological analysis in breast cancer samples.

In some embodiments, a multispectral imaging system is mounted on an inverted fluorescence microscope for wavelength-resolved imaging and data acquisition of the fluorescing nanoparticles.

In some embodiments, the target is a low-abundant or rare target such as a tumor-associated macrophage, stem cell, circulating tumor cells in peripheral blood, circulating fetal cells, stem cells, somatic cells, HIV-infected T cells, bacteria in water, adenoviruses, enteroviruses, hepatitis A and E, dengue, Swine Flu, bovine diarrhea, or protozpa/helminthes.

### BRIEF DESCRIPTION OF THE FIGURES

FIG. 1 summarizes the protein biomarkers and quantum dot-antibody conjugates for the detection and differentiation of malignant Hodgkin's and Reed-Sternberg (HRS) cells from infiltrating T and B cells.

FIG. 2 shows an illustration of multiplexed QD tissue staining in which two primary antibodies from two animal species (e.g., primary rabbit and mouse antibodies) are used to recognize two tissue antigens. After washing, a mixture of two secondary antibody-QD conjugates is applied to stain the two primary antibodies. The same procedure is repeated using primary antibodies for additional antigens, followed by the use of secondary antibody QD conjugates.

FIG. 3 shows multiplexed QD staining images of HRS malignant cells and infiltrating immune cells on lymph node tissue specimens of a Hodgkin's lymphoma patient. (A) Malignant HRS cells (red membrane, blue nuclear, and read/whitish Golgi) are identified by a unique multiplexed staining pattern of CD30 positive (membrane staining), CD15 positive (Golgi staining), Pax5 positive (nuclear staining), and CD45 negative. They are differentiated from infiltrating B cells (blue nuclear staining) and T cells (green membrane staining). A few prominent HRS cells are indicated with arrows. Scale bar: 100 μm. (B) Detailed view showing the distinct staining patterns of HRS cells, B cells, and T cells. Scale bar: 10 μm.

FIG. 4 compares deconvolved QD images with conventional single-marker IHC using adjacent tissue sections of lymph node biopsies. The deconvolved QD images were obtained from multiplexed QD data by spectral imaging and separation. The single-marker IHC images were obtained from adjacent tissue sections following standard protocols. The protein biomarkers are (a) CD45, (b) CD30, (c) Pax5, and (d) CD15. Scale bar: 100 μm. A detailed comparison of single cells is shown in insets (expanded).

FIG. 5 shows multiplexed QD staining images of lymph node biopsies from six patients of Hodgkin's lymphoma. Malignant HRS cells were detected in all patients by the QD staining pattern of CD30 positive, CD15 positive, Pax5 positive, and CD45 negative (expanded insets). Confirming diagnosis was carried out by experienced pathologists at the Atlanta VA Medical Center. Scale bar: 100 μm.

FIG. 6 shows Multiplexed QD staining images of lymph node biopsies from two patients with “suspicious” lymphoma (a and b), and from two patients with reactive lymph nodes (c and d). The expanded insets reveal the presence of rare malignant HRS cells in (a) and (b) but the absence of such cells in the biopsies of reactive lymph node patients (c and d). Scale bar: 100 μm.

### DETAILED DESCRIPTION

### Terms

A “subject” refers to any animal, typically a human, livestock, or pet.

As used herein, “nanoparticle” refers to any matter with at least one dimension between about 1 nm and 1000 nm with the ability to provide fluorescence, i.e., absorb light at one wavelength and emit light a different wavelength typically in the visual range. Examples of nanoparticles include quantum dots, quantum wires, and quantum wells. Typically, nanoparticles that fluoresce have a dimension between about 1 nm and 100 nm. Nanoparticles may be homogeneous or heterogeneous in composition and monodisperse or heterodisperse in size or shape.

Fluorescent nanoparticles are typically semiconductors. Noble metal nanoparticles, such as gold and silver, have also been shown to fluoresce. Lee, T., et al., Acc. Chem. Res., 2005, 38: 534-541. The semiconductor nanocrystal may consist of a core and a shell of different materials. Semiconductor nanocrystals are typically composed of elements from Groups II-VI, III-V, or IV or alloys or combinations thereof.

Nanoparticles may be modified with one or more biological molecules with affinity for one or more biological targets such as antigens or proteins. Such a modified nanoparticle may be called a nanoparticle conjugate. Semiconductor nanocrystals may be modified with molecules with affinity for biological targets as described in U.S. Pat. No. 6,207,392, hereby incorporated by reference.

Typical nanoparticles used for fluorescence include quantum dots (QDs). QDs are semiconductor nanocrystals with quantum confinement in three dimensions. QDs have a characteristic spectral emission upon excitation, which is tunable to a desired energy by varying the size and composition of the QDs as described in U.S. Pat. No. 6,306,610, hereby incorporated by reference. The spectral emission may be tuned to fall in the UV, visible, or infra-red regions. QDs and bioconjugated QDs are commercially available from Invitrogen and Evident Technologies. Several techniques for synthesizing QDs and bioconjugated QDs are known in the literature. E.g., U.S. Pat. No. 6,306,610, U.S. Pat. No. 6,207,392, and U.S. Pat. No. 7,498,177.

The term “marker” refers to any molecular entity that may bind a desired target which can then be identified, e.g., chemical or spectroscopic means. Typically markers are antibodies, but it is also contemplated that other markers may be used such as lectins, which typically bind certain glycoproteins or glycans, and aptamers, nucleic acids that are developed to bind certain molecules and can be detected through a dye conjugated complementary nucleic acid sequence or amplification by PCR.

As used herein, “multiplexing” refers to the simultaneous detection of fluorescent compositions with a plurality of spectral emissions. A plurality of spectral emissions may be obtained by varying the size, such as the diameter, or the composition of the mixture of nanoparticles. While the emission spectra of semiconductor nanocrystals may be narrow, the excitation wavelengths may be broad, allowing for multiplexing with exposure to only a single source light. Because QDs have been shown to be capable of narrow emission spectra and nearly Gaussian symmetrical line shapes, QDs may not only be chosen for improved optical resolution of fluorescence upon excitation over conventional organic dyes, but also allow for multiplexing. U.S. Pat. No. 6,306,610 B1.

As used herein, “rare” or “low-abundant” refers to a paucity of a biological target within a heterogeneous or complex sample. The scarcity of the biological target typically makes it difficult to identify or isolate the rare target. Some examples of low-abundant targets include circulating tumor cells in peripheral blood, circulating fetal cells, stem cells, somatic cells, HIV-infected T cells, bacteria in water, adenoviruses, enteroviruses, hepatitis A and E, dengue, Swine Flu, bovine diarrhea, and protozpa/helminthes as described in Dharmasiri, U., et al., Annu. Rev. Anal. Chem., 2010, 3:409-31 which is hereby incorporated by reference. Other examples include Hodgkin's and Reed-Sternberg (HRS) cells in lymph tissue. Traditional methods of differentiating rare target cells such as magnetic sorting, filtering, and fluorescence with organic molecules may be labor intensive, require high throughput processing to achieve statistical significance, or may lead to ambiguous results.

The term “antibody” refers to a protein used by the immune system to identify foreign objects. The antibody recognizes and binds to a unique part of the target, termed an antigen or epitope. Antibodies may be generated to recognize almost any target peptide fragment, typically between 5 to 10 amino acids. An antibody contains a paratope which is the region on the antibody that binds a particular epitope. As used herein the term is intended to include antibody fragments provided they recognize the desired epitope. The term is not intended to be limited to those produced by any specific animal.

Numerous methods known to those skilled in the art are available for obtaining antibodies or antigen-binding fragments thereof. For example, antibodies can be produced using recombinant DNA methods (U.S. Pat. No. 4,816,567). Monoclonal antibodies may also be produced by generation of hybridomas in accordance with known methods. Hybridomas formed in this manner are then screened using standard methods, such as enzyme-linked immunosorbent assay (ELISA) and surface plasmon resonance analysis, to identify one or more hybridomas that produce an antibody that specifically binds with a specified antigen. Any form of the specified antigen may be used as the immunogen, e.g., recombinant antigen, naturally occurring forms, any variants or fragments thereof, as well as antigenic peptide thereof.

One exemplary method of making antibodies includes screening protein expression libraries, e.g., phage or ribosome display libraries. Phage display is described, for example, in U.S. Pat. No. 5,223,409.

In addition to the use of display libraries, the specified antigen can be used to immunize a non-human animal, e.g., a rodent, e.g., a mouse, hamster, or rat. In one embodiment, the non-human animal includes at least a part of a human immunoglobulin gene. For example, it is possible to engineer mouse strains deficient in mouse antibody production with large fragments of the human Ig loci. Using the hybridoma technology, antigen-specific monoclonal antibodies derived from the genes with the desired specificity may be produced and selected. U.S. Pat. No. 7,064,244.

In another embodiment, a monoclonal antibody is obtained from the non-human animal, and then modified, e.g., humanized, deimmunized, chimeric, may be produced using recombinant DNA techniques known in the art. A variety of approaches for making chimeric antibodies have been described. See, e.g., U.S. Pat. No. 4,816,567 and U.S. Pat. No. 4,816,397. Humanized antibodies may also be produced, for example, using transgenic mice that express human heavy and light chain genes, but are incapable of expressing the endogenous mouse immunoglobulin heavy and light chain genes. Winter describes an exemplary CDR-grafting method that may be used to prepare the humanized antibodies described herein (U.S. Pat. No. 5,225,539). All of the CDRs of a particular human antibody may be replaced with at least a portion of a non-human CDR, or only some of the CDRs may be replaced with non-human CDRs. It is only necessary to replace the number of CDRs required for binding of the humanized antibody to a predetermined antigen.

Humanized antibodies or fragments thereof can be generated by replacing sequences of the Fv variable domain that are not directly involved in antigen binding with equivalent sequences from human Fv variable domains. Exemplary methods for generating humanized antibodies or fragments thereof are provided by U.S. Pat. No. 5,585,089; U.S. Pat. No. 5,693,761; U.S. Pat. No. 5,693,762; U.S. Pat. No. 5,859,205; and U.S. Pat. No. 6,407,213. Those methods include isolating, manipulating, and expressing the nucleic acid sequences that encode all or part of immunoglobulin Fv variable domains from at least one of a heavy or light chain. Such nucleic acids may be obtained from a hybridoma producing an antibody against a predetermined target, as described above, as well as from other sources. The recombinant DNA encoding the humanized antibody molecule can then be cloned into an appropriate expression vector.

In certain embodiments, a humanized antibody is optimized by the introduction of conservative substitutions, consensus sequence substitutions, germline substitutions and/or backmutations. An antibody or fragment thereof may also be modified by specific deletion of human T cell epitopes or “deimmunization” by the methods disclosed in U.S. Pat. No. 7,125,689 and U.S. Pat. No. 7,264,806. Briefly, the heavy and light chain variable domains of an antibody can be analyzed for peptides that bind to MHC Class II; these peptides represent potential T-cell epitopes. For detection of potential T-cell epitopes, a computer modeling approach termed “peptide threading” can be applied, and in addition a database of human MHC class II binding peptides can be searched for motifs present in the VH and VL sequences. These motifs bind to any of the 18 major MHC class II DR allotypes, and thus constitute potential T cell epitopes. Potential T-cell epitopes detected can be eliminated by substituting small numbers of amino acid residues in the variable domains, or preferably, by single amino acid substitutions.

Typically, conservative substitutions are made. Often, but not exclusively, an amino acid common to a position in human germline antibody sequences may be used. The V BASE directory provides a comprehensive directory of human immunoglobulin variable region sequences. These sequences can be used as a source of human sequence, e.g., for framework regions and CDRs. Consensus human framework regions can also be used, e.g., as described in U.S. Pat. No. 6,300,064.

“Primary antibodies” refer to antibodies that bind directly with target epitopes of specific biomarkers. “Secondary antibodies” refer to antibodies that have an epitope as a part of a primary antibody. Researchers typically use secondary antibodies in immunofluorescence to magnify the fluorescence signal when the fluorescence signal from fluorescent dyes or nanocrystals conjugated to primary antibodies is too weak to discern.

### Hodgkin's Lymphoma

Multiplexed detection and characterization of rare rumor cells in Hodgkin's lymphoma with multicolor quantum dots is disclosed in Liu et al., Anal Chem. 2010, 82(14): 6237-6243, hereby incorporated by reference in its entirety. This is not an admission of prior art. Hodgkin's Lymphoma is cancer predominantly of the lymphoid tissues. The American Cancer Institute estimated that approximately 8,500 Americans would be diagnosed with Hodgkin's Lymphoma in 2010. Clinical presentation of Hodgkin's comprises enlarged lymph nodes, enlarged spleen, fever, weight loss, and fatigue. Hodgkin's and Reed-Sternberg (HRS) cells are a class of malignant cells that are a pathological hallmark in clinical diagnosis of Hodgkin's lymphoma. HRS cells exhibit apoptosis resistance and are usually characterized by their relatively large size and plurality of nuclei with prominent nucleoli. An absence of HRS cells has high negative predictive value for classic Hodgkin's lymphoma.

In Hodgkin's lymphoma, HRS cells are rare because they comprise only about 1% of the heterogeneous infiltrating cells in lymph node tissues. HRS cells are surrounded by heterogeneous infiltrating cells such as T-lymphocytes, B-lymphocytes, histocytes, eosinophilic granulocytes, and plasma cells. Therefore, it is challenging with traditional techniques to definitively identify HRS cells from the noisy background of other cell populations. Conventional techniques such as morphological hematoxylin and eosin stain staining (H and E) and immunohistochemistry (IHC) are limited by their inability to perform multiplexing.

Negative CD45 expression is one of the major characteristics defining Hodgkin and Reed-Sternberg cells. “CD45” is a transmembrane protein involved in costimulation of differentiated hematopoietic cells. It is expressed in mature activated T-cells and a subpopulation of resting T-cells but is absent in the HRS cells of classic Hodgkin's lymphoma. However, one of the most frequent problems using conventional IHC is that the numerous adjacent CD45+ inflammatory cells can bring up interference on interpreting CD45 expression of the Hodgkin tumor cells. If pathologists cannot definitively identify HRS cells, they may be forced to give the ambiguous diagnosis of “suspicious Hodgkin's Lymphoma.” Similarly, it may be difficult for pathologists to differentiate cells of reactive lymph nodes, or benign enlargement of the lymph nodes in response to infection, from Hodgkin's Lymphoma.

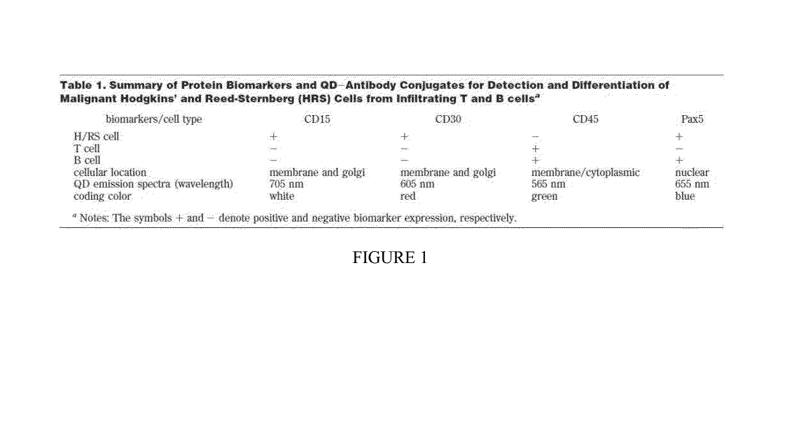

By contrast, QD staining allows visualization of multiple biomarkers simultaneously. With QDs, some biomarkers such as CD15 and CD30 can define the boundary of suspicious Hodgkin tumor cells. As shown in FIG. 1, “CD15” is a transmembrane protein expressed in HRS cells and certain types of epithelial cells. “CD30” is a cytokine receptor belonging to the tumor necrosis factor (TNF) receptor superfamily, and it is expressed in HRS cells, anaplastic large cell lymphomas, and some activated T cells and B cells. Pax5 can also be targeted with QDs to identify cell certain nuclei. “Pax5” is a protein biomarker used for detecting the cell nuclei of B-cell lineage and classic Hodgkin's lymphoma.

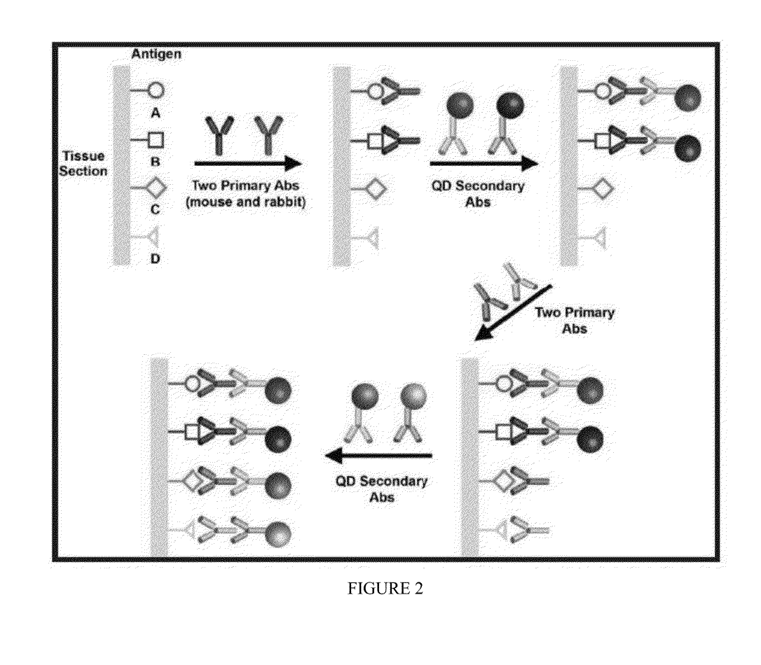

In one embodiment, QD targeting moieties to CD15, CD30, CD45 and Pax5 can be used in a multiplexed manner to detect and differentiate the malignant HRS cells from infiltrating immune cells such as T and B lymphocytes. In one embodiment, a plurality of QD biomarkers is used in direct immunofluorescence to differentiate HRS cells from surrounding cells. In another embodiment, a plurality of QD biomarkers is used in indirect immunofluorescence to determine whether cells are Hodgkin tumor cells or their inflammatory neighbors. As shown in FIG. 2, quantum dots conjugated with secondary antibodies may be used in a sequential manner to build up the degrees of multiplexing. This multicolor indirect method produces brighter fluorescence for more reliable results. Also, this indirect approach requires antibodies from only two animal species that are available in high quality and large quantities at low costs. In one embodiment, the QD-antibody-antigen complex is cross-linked using common tissue fixatives such as formaldehyde, glutaraldehyde, or ethyl dimethylaminopropyl carbodimide (EDC) in order to prevent the dissociation of the secondary antibody from the primary antibody or the primary antibody from dissociating from the tissue antigen.

An excess of QDs conjugated with secondary antibodies can be used to deplete the antigenic sites on primary antibodies when the binding mixture is incubated for an extended period of time (2 to 3 h). Under these conditions, the percentage of “empty” epitopes on the primary antibody is largely determined by the equilibrium constant of primary antibody and QD-secondary antibody binding, thereby avoiding the complications of time-dependent binding kinetics. As a result, during the second round of staining in indirect immunofluorescence, QD binding takes place mainly at the new primary antibody sites (introduced during the second round). Sequential QD staining using two protein biomarkers results in non-specific binding of less than 5-10% of their specific binding signals, a level that is low enough for multiplexed QD studies on tissue specimens. Liu, J., et al. ACS Nano (2010) 4:2755-65.

The development of techniques for obtaining needle biopsy samples promises minimal invasiveness to the patients. On the other hand, the mass availability of biopsy samples limits the applications of conventional staining methods. However, multiplexed QDs provide high sensitivity to detect rare cells of diagnostic value out of a large population of noisy cells and also reduce the requirement of previous sample materials. In one embodiment, multiplexed QD staining can be used to detect rare cells within needle biopsy samples. With this embodiment, patients of Hodgkin's disease will benefit by “on the spot” sampling and more reliable monitoring of disease status and therapeutic response. The treatment methods can be adjusted accordingly based on the information of monitoring by QD multiplexing.

In one embodiment, multiplexed QD-antibody conjugates and wavelength-resolved imaging may be used to identify low-abundant HRS cells on lymph node biopsies of classical Hodgkin's lymphoma patients. The use of multiple protein biomarkers, such as a combination of protein biomarkers comprising CD45, CD15, CD30, and PAX5, allows rapid detection and differentiation of rare HRS cells from their complex micro environments.

In another embodiment, multiplexed QD-antibody conjugates can be used to detect cancer stem cells. In another embodiment, multiplexed QD-antibody conjugates can be used to detect tumor-associated macrophages (TAMs). In another embodiment, multiplexed QD-antibody conjugates can be used to detect other rare or low-abundant populations.

### EXPERIMENTAL

### Example 1

### Malignant HRS Cells are Detected and Identified by a Distinct Emission Pattern from a Plurality of QD Probes

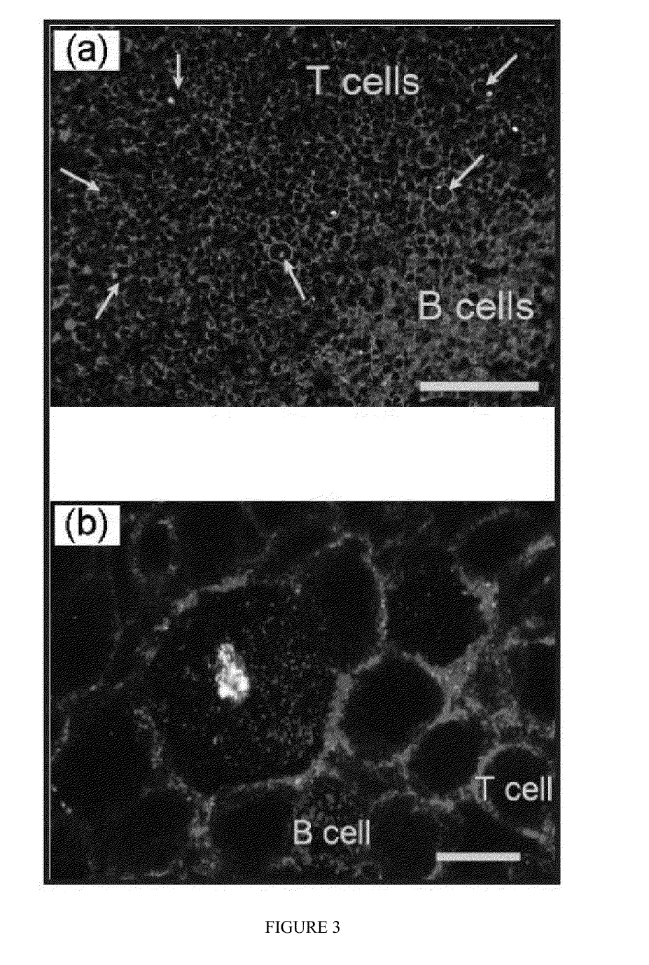

FIG. 3 shows multiplexed QD staining images that differentiate HRS malignant cells from infiltrating immune cells on lymph node tissue specimens of a Hodgkin's lymphoma patient. To prepare the samples for QD staining, deidentified human tissue sections of archived formalin-fixed paraffin-embedded (FFPE) blocks were obtained from the Veteran Affairs Medical Center in Decatur, Ga. Tissue slices (approximately 5 μm thick) were sectioned and placed on positively charged glass slides. The slides were preheated at 60-65° C. for 15 min and then went through the steps of deparaffinization using xylene. Hydration of the slides was performed using a series of ethanol solutions of decreasing concentrations (100%, 95%, 80%, and 70%, twice for each concentration, 2 min in each step). Antigen retrieval was performed using a decloaking chamber (125° C. for 30 s, then 90° C. for 10 s) with common decloaking buffers (Biocare Medical, Concord, Calif.). The slides were cooled in the decloaking buffer for 20 min, washed in DI water, and stored in 1×PBS plus buffer (containing 0.05% Tween 20).

Multiplexed QD staining was performed as shown in FIG. 2. The procedure was conducted at room temperature, using an automated tissue processing and staining instrument (Nemesis 7200, Biocare Medical, Concord, Calif.). The use of this robotic system reduced slide-to-slide variations and allowed staining experiments in a high throughput manner. In the preprogrammed procedure, the slide surface was blocked by 2% BSA/5% goat serum/1×PBS for 30 min at room temperature. The slides were incubated with a mixture of the primary antibodies CD30 (mouse monoclonal, clone Ber-H2, 1:25 dilution, Dako) and Pax5 (rabbit polyclonal, RB-9406-P1, 1:25 dilution, Thermo Fisher Scientific Inc., Fremont, Calif.) for 1 h. After washing with 1×PBS plus buffer twice, a mixture of the secondary antibody conjugated Qdots (goat antirabbit QD655 and goat antimouse QD605, Invitrogen) was applied to the slides for 2 h. The slides were washed with 1×PBS plus buffer three times. Then, another cycle of QD immunostaining was performed for two additional antigens, using a mixture of the primary antibodies CD15 (mouse monoclonal, clone C3D-1, 1:20 dilution, Dako, Carpinteria, Calif.) and CD45 (rabbit polyclonal, sc-25590, 1:25 dilution, Santa Cruz Biotechnology Inc., Santa Cruz, Calif.) and a mixture of goat antirabbit QD565 and goat antimouse QD525 (Invitrogen, Carlsbad, Calif.). Then, 4′,6-diamidino-2-phenylindole (DAPI) counterstaining (100 ng/mL) was performed, followed by washing with DI water. The slides were dehydrated and a covered with a coverslip using mounting media (Ecomount, Biocare Medical, Concord, Calif.).

A multispectral imaging system (Nuance, CRI, Woburn, Mass.) was mounted on an inverted fluorescence microscope (Olympus I×71, Olympus America Inc., Center Valley, Pa.) for wavelength-resolved imaging and data acquisition. Near-UV excitation at 350 nm was obtained with a mercury lamp, and a long-pass filter was used to pass the QD fluorescence signals. A series of images (called image stacks or image cubes) were captured in the wavelength range of 500 800 nm at 10 nm increments with a liquid-crystal tunable filter. A spotted array of QDs on the glass slide was used to construct a library of individual QD spectra. Tissue background (autofluorescence) spectra were obtained from control (unstained) specimens.

Malignant HRS cells were identified by a unique multiplexed staining pattern of CD30 positive (red membrane staining), CD15 positive (red/white Golgi staining inside red circle), Pax5 positive (blue nuclear staining), and CD45 negative. They are differentiated from infiltrating B cells (blue nuclear staining) and T cells (green membrane staining) Quantitative image analysis reveals that CD30 and CD15 are colocalized in HRS cells (especially in the Golgi, see FIG. 3b), but the membrane staining signal of CD30 is much stronger than that of CD 15, thus resulting in the predominantly “red” color observed at the HRS cell membrane. CD30+, CD15+, Pax5+ cells are also CD45−.

This experiment shows that administration of multicolor QD probes resulted in a distinctive emission pattern for the identification of rare HRS cells without the need for multiple tissue sections.

### Example 2

### Performance of Multiplexed QD Probes Compared to Traditional Single-Color Immunohistochemistry (IHC)

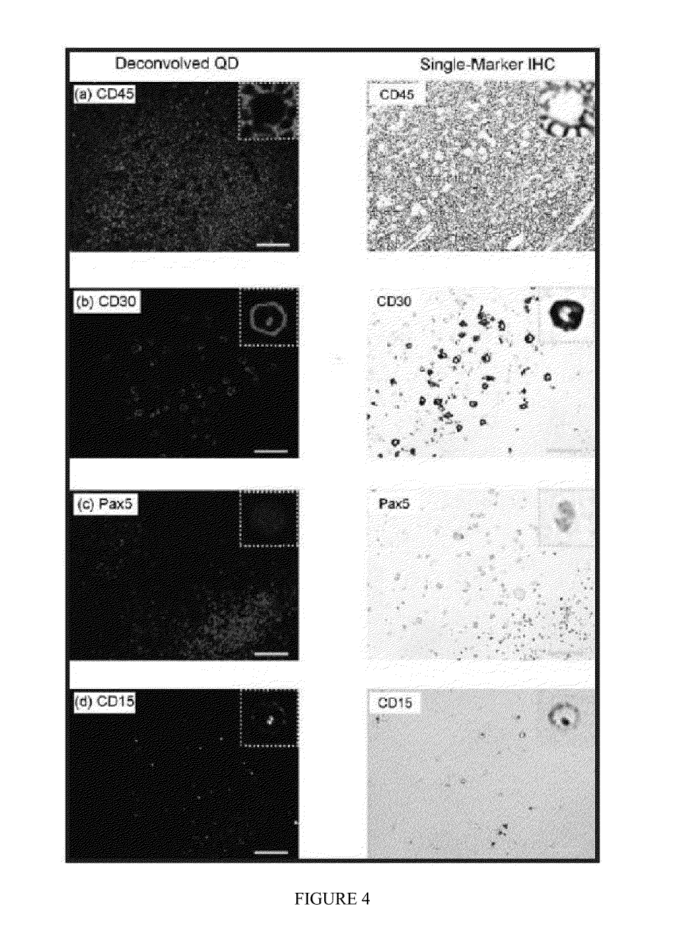

FIG. 4 compares deconvolved QD images with conventional single-marker IHC using adjacent tissue sections of lymph node biopsies. A series of five consecutive tissue slices were obtained from a Hodgkin's lymphoma patient because adjacent tissues contain similar cellular contents and morphological features. One slice was used for multiplexed QD staining (four biomarkers, as described above), and the remaining four slices were used for conventional single-color IHC staining (one marker on each tissue section).

For traditional immunohistochemistry, consecutive slides from the same tissue block were stained using standard DAB chromagen immunohistochemistry. One protein biomarker was stained on one tissue section. Briefly, after tissue pretreatment and subsequent endogenous enzyme blocking for 15 min, the slides were loaded into the same autostaining machines. The MACH-4 detection system (Biocare Medical, Concord, Calif.) was used for enhanced sensitivity. The routine counterstaining step with hematoxylin was omitted so that monocolor images from control slides could be used for comparison. The single-marker IHC images were obtained from four adjacent tissue sections following standard protocols. The protein biomarkers are (a) CD45, (b) CD30, (c) Pax5, and (d) CD15.

Images of IHC-stained tissues were acquired using a color CCD camera attached to an inverted Olympus microscope. The multiplexed QD image was separated by spectral deconvolution into four single-color images corresponding to the expression patterns of individual biomarkers (FIG. 4, left). The deconvolved QD images are then compared with the single-color IHC images obtained from the same area of interest on adjacent tissue sections (FIG. 4, right). It should be noted that the adjacent tissue sections are similar but not identical, so this comparison is only approximate. By and large, the deconvolved QD images contain similar features and patterns as the IHC images, indicating that multiplexed QD staining is well correlated with IHC. For example, the QD and IHC images of CD45 expression show consistently membrane-stained T cells, and CD30 and CD15 double staining is observed for malignant HRS cells with both QD and IHC. For the nuclear biomarker PAX5, both QD and IHC staining reveals more intense signals in the nuclei of B cells than that of HRS cells. Detailed images of single cells are shown in insets (expanded). QD probes resulted in the identification of similar features and patterns as traditional single-color immunohistochemistry (IHC) with the added benefit of multiplexing one sample rather than needing four samples as in IHC.

### Example 3

### Multiplexed QDs Rapidly Identified Positive Lymphoma Patients

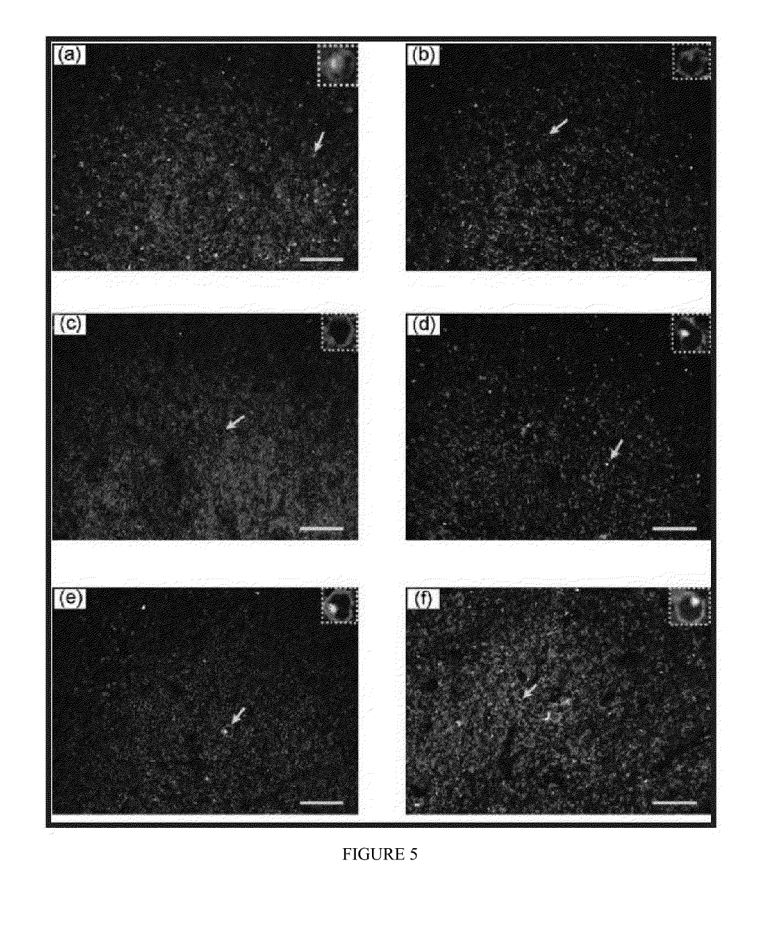

FIG. 5 shows multiplexed QD staining images of lymph node biopsies from six patients with Hodgkin's lymphoma. Malignant HRS cells were detected in all patients by the unique QD staining pattern of CD30 positive, CD15 positive, Pax5 positive, and CD45 negative (expanded insets). Pathological examination by experienced pathologists at the Atlanta VA Medical Center confirmed that these six patients had definitive Hodgkin's lymphoma.

### Example 4

### Multiplexed QDs Identified HRS Cells in Two Patients that Conventional Methods of Diagnosis Deemed to have Suspicious Lymphoma

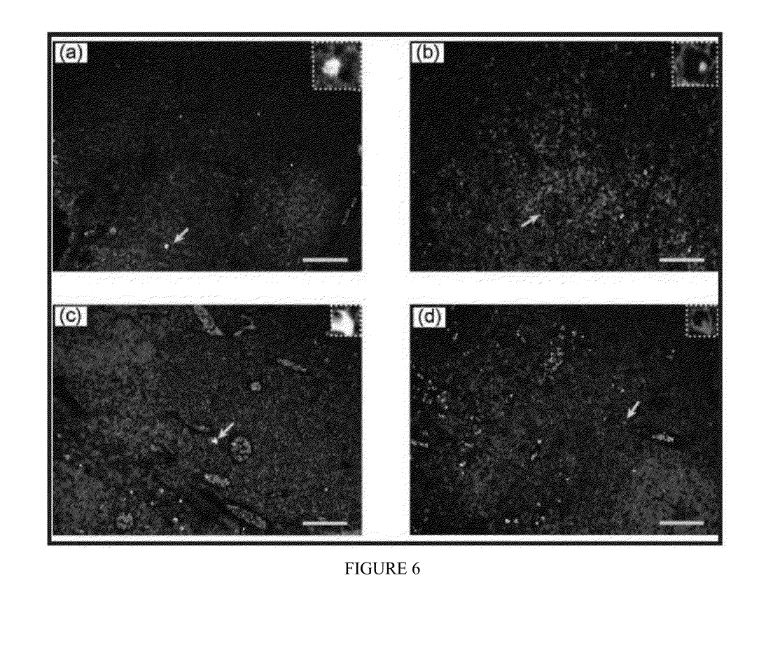

FIG. 6 (a and b) shows multiplexed QD staining images of lymph node biopsies from two patients in which traditional immunohistochemistry deemed as exhibiting “suspicious” lymphoma. The unique QD staining pattern for HRS cells is observed in the two suspicious lymphoma patients, but the number of malignant HRS cells is extraordinarily small. This low number is likely responsible for the diagnostic ambiguity with traditional methods. The multiplexed QDs identified the extremely rare cells where traditional methods led to ambiguous diagnoses.

### Example 5

### The Unique Staining Pattern of HRS Cells from Exposure to Multiplexed QDs is Absent in Patients with Reactive Lymph Nodes (Benign Lymphoma)

FIG. 6 (c and d) shows the absence of the unique staining pattern of HRS cells in the biopsies of reactive lymph node patients. There is a small population of cells with CD15 (white) and CD30 (red) expressions; however, they do not simultaneously express the biomarker Pax5, so these cells are different from the malignant HRS cells identified in the lymphoma patients. This experiment shows that multiplexed QDs can differentiate reactive lymph nodes from Hodgkin's lymphoma.

We claim:

1. A method comprising mixing a sample with a nanoparticle-conjugated marker with affinity for a target providing a marked target wherein said target is a primary antibody with affinity to a cell biomarker.

2. The method of claim 1, wherein the cell biomarker is a cell surface biomolecule or an intracellular biomolecule.

3. The method of claim 1, wherein said sample comprises a human lymphoma tissue that has been incubated with at least one primary antibody each primary antibody having an epitope to a fragment of a protein selected from the group consisting of CD15, CD30, CD45, and Pax5.

4. A method of claim 3 further comprising the step of mixing the human lymphoma tissue with a second set of primary antibodies having epitopes selected from the group consisting of CD15, CD30, CD45, and Pax5 that were not used in the first instance wherein the nanoparticle-conjugated marker is a mixture of nanoparticle-conjugated secondary antibodies each with affinity to a different primary antibody used in the second instance.

5. A method of claim 4 further comprising the step of exposing the human lymphoma tissue to light; and diagnosing Hodgkin's Lymphoma by identifying a distinct emission pattern for the nanoparticle-conjugated secondary antibodies identifying Hodgkin's and Reed-Sternberg cells

6. A kit for diagnosing Hodgkin's lymphoma in a subject, the kit comprising: primary antibodies with epitopes for CD15, CD30, CD45, and Pax5; and a plurality of quantum dot-conjugated secondary antibodies to the primary antibodies.

7. The kit of claim 6, wherein the quantum dot-conjugated secondary antibodies are water soluble.

8. A method of diagnosing benign lymphoid hyperplasia, the method comprising:
performing the method of claim 5; and identifying benign cells by the absence of the distinct emission pattern for Hodgkin's and Reed-Sternberg cells.

9. The method of claim 1, further comprising imaging said sample with a multispectral imaging system.

10. A method of detecting a cell in a tissue sample comprising
a. mixing the sample with a first primary antibody with an epitope to a first cell biomarker and a second primary antibody with an epitope to a second biomarker providing antibody conjugated cells comprising the first and second cell biomarkers;
b. mixing the antibody conjugated cells with a first secondary antibody conjugated to a first nanoparticle with an epitope to the first primary antibody and a second secondary antibody conjugated to a second nanoparticle with an epitope to the second primary antibody providing antibody conjugated cells marked with first and second nanoparticles, provided that the first and second nanoparticles fluoresce at detectably different wavelengths;
c. exposing the sample with antibody conjugated cells marked with first and second nanoparticles to light;
d. detecting a fluorescence pattern for a cell indicative of the first and second cell biomarkers.

11. The method of claim 10, further comprising the step of e) assigning a first pattern of fluorescence to a normal cell; and f) correlating a second pattern of fluorescence to an irregular cell.

12. The method of claim 11, further comprising the step of g) reporting the presence of an irregular cell to the subject.

13. The method of claim 10, wherein the tissue sample is human lymphoma tissue.

14. The method of claim 11, wherein the normal cell is a T and B lymphocyte and the irregular cell is a Hodgkins' and Reed-Sternberg cell.

15. The method of claim 10, wherein the first cell biomarker is selected from CD15, CD30, CD45, and Pax5 and the second cell biomarker is selected from CD15, CD30, CD45, and Pax5 provided it is not the same as the first biomarker.

16. A method of detecting a cell in a tissue sample comprising
a. mixing the tissue sample with an antibody-conjugated nanoparticle each having an epitope to a target biomolecule, providing an antibody conjugated cell marked with an antibody-conjugated nanoparticle, provided that two or more antibody-conjugated nanoparticles are used that fluoresce at detectably different wavelengths from each other and bind different target biomolecules;
b. exposing the tissue sample with antibody conjugated cells marked with a nanoparticle to light;
c. detecting a fluorescence pattern for a targeted cell.

17. The method of claim 16, further comprising the step of e) assigning a first pattern of fluorescence to a normal cell; and f) correlating a second pattern of fluorescence to an irregular cell.

18. A method of detecting a cell in a tissue sample comprising
a. mixing the sample with a first marker that binds a cell biomarker providing marker conjugated cells;
b. mixing the marker conjugated cells with a secondary marker conjugated to a nanoparticle that binds to the first marker providing marker conjugated cells marked with nanoparticles;
c. exposing the sample with marker conjugated cells marked with nanoparticles to light;
d. detecting a fluorescence pattern for a cell indicative of the cell biomarker.

19. The method of claim 17 wherein the tissue sample is lymphoma tissue.

20. The method of claim 17, wherein steps a and b are repeated two or more times with first markers that bind different cell biomarkers.
